(19) United States
(12) Patent Application Publication
(10) Pub. No.: US 2009/0183351 A1
(43) Pub. Date: Jul. 23, 2009

(54) SEWER LATERAL CAP PULLER

(75) Inventor: DOUGLAS G. BUTTZ, Noblesville, IN (US)

Correspondence Address: BAKER & DANIELS LLP, 300 NORTH MERIDIAN STREET, SUITE 2700, INDIANAPOLIS, IN, 46204, US

(73) Assignee: TZ Products, Inc., Noblesville, IN (US)

(21) Appl. No.: 12/016,238

(22) Filed: Jan. 18, 2008

(51) Int. Cl. B25B 27/02; B23P 19/04

(52) U.S. Cl. 29/426.5; 29/278

(57) ABSTRACT

A cap puller tool is disclosed. The cap puller tool may be used to remove a sewer lateral cap from a sewer lateral pipe. The cap puller tool may include a drill tool, an engagement tool, a handle, and a coupler.

### FIELD OF THE INVENTION

The present invention relates generally to cap puller tools and more particularly to cap puller tools for use with a sewer lateral cap.

### BACKGROUND OF THE INVENTION

Often in construction a sewer main pipe is installed along with sewer lateral pipes in fluid communication with the sewer main pipe at locations. Exemplary locations for the sewer lateral pipes include lots in a residential neighborhood. These sewer lateral pipes have caps coupled thereto to close off the sewer lateral pipe from the outside environment. When the time comes to connect a sewer line from a facility, such as a home or business, to the sewer lateral pipe the end of the sewer lateral pipe is unearthed. The sewer lateral cap is removed from the sewer lateral pipe and the line from the facility is connected to the sewer lateral pipe bringing the line from the facility into fluid communication with the sewer main line.

The removal of the sewer lateral cap on the end of the sewer lateral pipe is typically accomplished by prying. Additional devices for the removal of the sewer lateral cap from the sewer lateral pipe are provided in U.S. Pat. Nos. 4,691,424; 4,786,214; and 5,003,682 and US Published Patent Application Pub. No. 2002/0144572.

### SUMMARY OF THE INVENTION

In an exemplary embodiment of the present disclosure, a cap puller is disclosed which engages an inner portion of a cap, the inner portion being spaced apart from an edge of the cap.

In another exemplary embodiment of the present disclosure, a method of removing from a sewer lateral pipe a sewer lateral cap is provided. The sewer lateral cap having a first side exposed to the fluid carrying portion of the sewer lateral pipe. The method including the steps of engaging a portion of the first side of the sewer lateral cap which is exposed to the fluid carrying portion of the sewer lateral pipe with a tool, the portion being spaced apart from an edge of the sewer lateral cap, and removing the sewer lateral cap with the tool. In one example, the step of removing the sewer lateral cap with the tool includes the step of translating the tool in a first direction. The first direction being generally aligned with a longitudinal axis of the sewer lateral pipe. In another example, the method further includes the steps of creating an opening in the sewer lateral cap spaced apart from an edge of the sewer lateral cap and passing a first engagement member of the tool through the opening. The first engagement member being used to engage the portion of the first side of the sewer lateral cap.

In a further exemplary embodiment of the present disclosure, a cap puller for removing a cap having an opening created therein which is spaced apart from an edge of the cap is provided. The cap puller including an engagement tool including a main body portion, a first engagement member supported by the main body portion, and a second engagement member supported by the main body portion. The first engagement member having a first configuration and a second configuration which has a larger lateral profile than the first configuration. The first engagement member passes through the opening in the cap in the first configuration and engages an inside portion of the cap proximate the opening in the second configuration. The second engagement member engages an outside portion of the cap proximate the opening. The cap puller further includes an actuator coupled to the first engagement member. The actuator positions the first engagement member in at least one of the first configuration and the second configuration. In one example, the first engagement member is rotatable relative to the main body portion, the actuator being translatable to cause a rotation of the first engagement member. In another example, the second engagement member is translatable relative to the main body portion to move the second engagement member from a first position spaced apart from the outside portion of the cap to abutting the outside portion of the cap. In a further example, the first engagement member is positionable independent of the second engagement member. In yet another example, the cap puller further includes a drill tool including a drill engagement portion and a cutting portion, the cutting portion being used to create the opening in the cap and a detachable handle which may be coupled to a coupler of the engagement tool.

In yet a further exemplary embodiment of the present disclosure, a cap puller for removing a cap having an opening created therein spaced apart from an edge of the cap is provided. The cap puller including a main body portion; means for engaging an inside surface of the cap proximate the opening; and means for engaging an outside surface of the cap proximate the opening. In one example, the cap puller further includes an actuator to position the means for engaging the inside surface of the cap proximate the opening. In another example, the cap puller further includes a detachable handle which is coupled to the main body portion and includes a bar for gripping by an operator.

In still another exemplary embodiment of the present disclosure, a cap puller for removing a cap having an opening created therein spaced apart from an edge of the cap is provided. The cap puller including a main body portion; a transport handle coupled to the main body portion; a first engagement member coupled to the main body portion and moveable relative to the main body portion; a holder supported by the main body portion; a detachable handle being received by the holder when in a storage position of the detachable handle and being coupled to a coupler of the main body portion when in a use position of the detachable handle; and a drill tool supported by the handle when in a storage position of the drill device. In one example, the handle is coupled to the main body portion with a coupler in the storage position of the handle. In another example, the cap puller further includes a second engagement member. The second engagement member supports the holder. The first engagement member engages an inside portion of the cap proximate the opening in the cap when in use. The second engagement member engages an outside portion of the cap proximate the opening when in use.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 illustrates a perspective view of components of a puller tool with a portion of the length of chain illustrated;

FIG. 2 illustrates a first perspective view of the components of the puller tool of FIG. 1 in a stored configuration for storage or transport;

FIG. 3 illustrates a second perspective view of the components of the puller tool of FIG. 1 in a stored configuration for storage or transport;

FIG. 4 illustrates a sewer lateral pipe having a sewer lateral cap coupled thereto and a cutting tool of the puller tool spaced apart therefrom;

FIG. 5 illustrates the sewer lateral cap having a hole made by the cutting tool of FIG. 4 and a first portion of an engagement tool being passed through the hole;

FIG. 6 illustrates the engagement tool of FIG. 5 coupled to the sewer lateral cap, the sewer lateral pipe and sewer lateral cap being shown in section; and

FIG. 7 illustrates the removal of the sewer lateral cap with the puller tool.

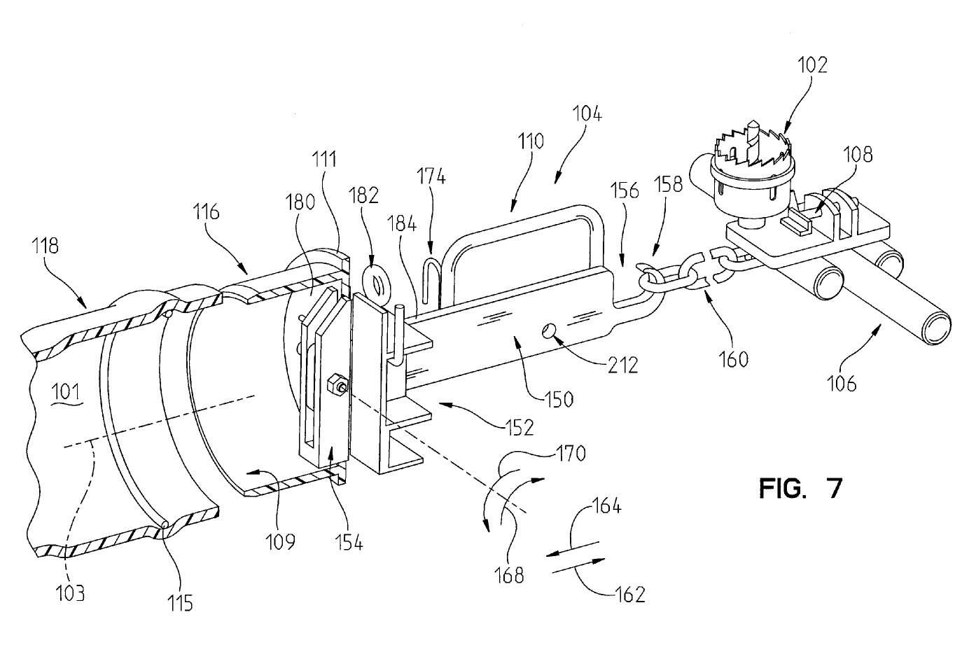

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention. Although the disclosure is described as a tool for removing a cap from sewer lateral, it should be understood that the concepts presented may be used in various applications and should not be limited to use in connection with a sewer lateral cap.

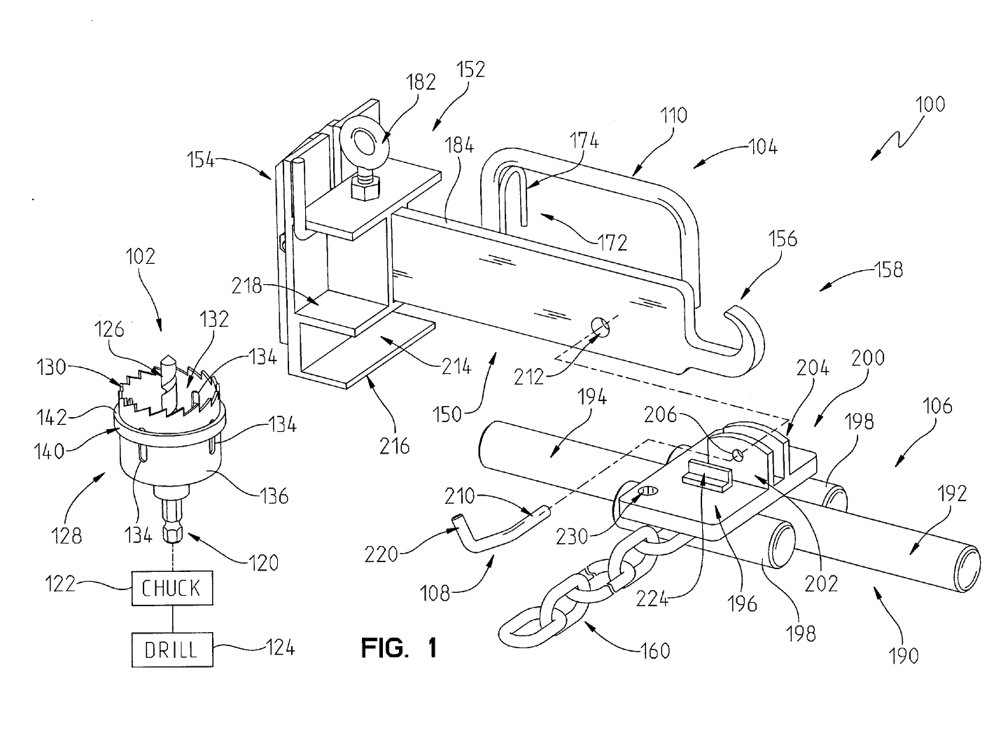

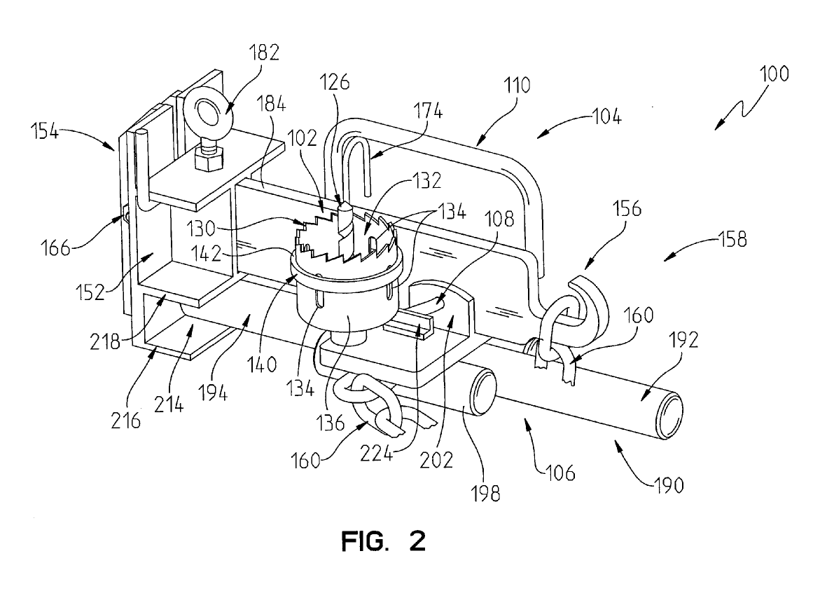

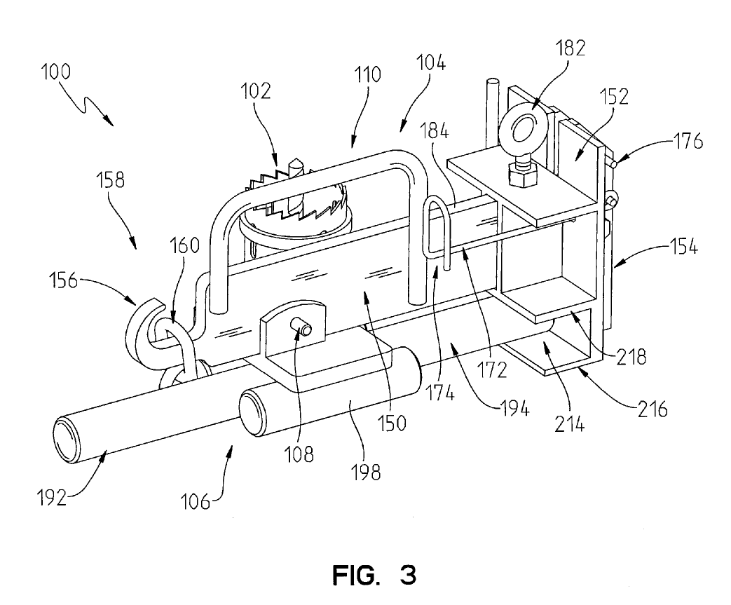

Referring to FIG. 1, a sewer lateral cap puller tool 100 is shown. Sewer lateral cap puller tool 100 includes a drill tool 102, an engagement tool 104, a handle 106, and a coupler 108. As shown in FIGS. 2 and 3, drill tool 102 and handle 106 may be assembled to engagement tool 104 to permit the carrying of sewer lateral cap puller tool 100 by an transport handle 110 and to facilitate the storage of sewer lateral cap puller tool 100. In FIGS. 2 and 3, handle 106 and drill tool 102 are shown in their respective storage positions.

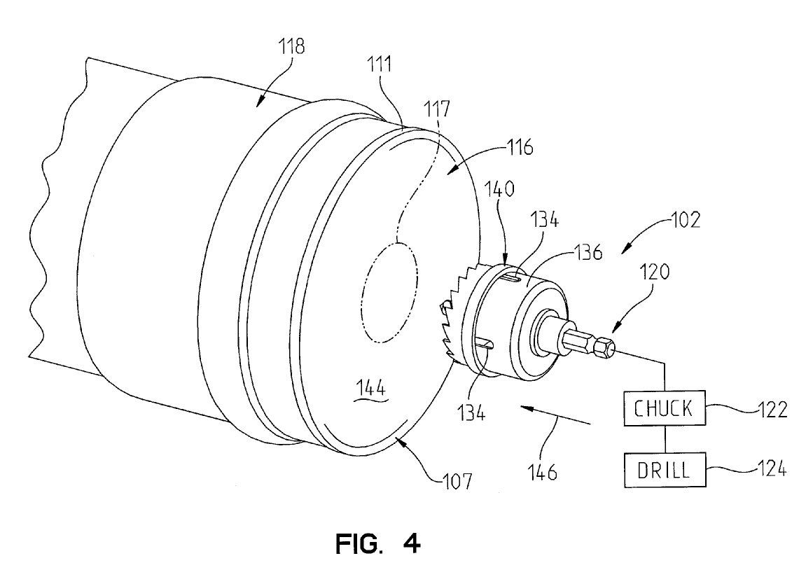

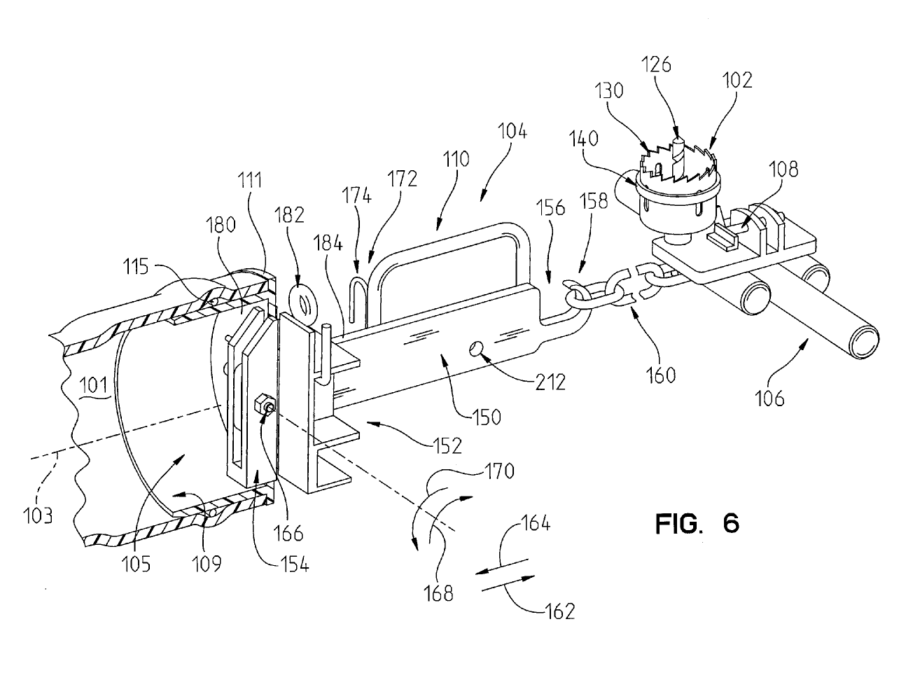

Sewer lateral cap puller tool 100 is used to remove a sewer lateral cap 116 (see FIG. 4) from a sewer lateral pipe 118 (see FIG. 4). Referring to FIG. 6, sewer lateral pipe 118 includes an interior 101 through which sewer fluid and components flow. Sewer lateral pipe 118 is a generally revolute pipe having a longitudinal axis 103 proximate sewer lateral cap 116. Sewer lateral cap 116 includes an inside portion 105 including surface 180 and an outside portion 107 (see FIG. 4) including surface 144 (see FIG. 4). Sewer lateral cap 116 includes a wall 109 which is received in sewer lateral pipe 118. Between sewer lateral pipe 118 and sewer lateral cap 116 a seal member 115 is provided. An exemplary seal member is an o-ring. In one embodiment, the sewer lateral cap is an outside cap which fits over an exterior of the sewer lateral pipe.

Returning to FIG. 1, drill tool 102 includes a drill engagement portion 120. Drill engagement portion 120 is configured to be received in and coupled to a chuck 122 of a drill 124. Exemplary drills include hand-operated drills, electric drills, and cordless drills.

Drill tool 102 includes a central cutting device 126 and an outer cutting device 128. Outer cutting device 128 includes teeth 130. Central cutting device 126 extends beyond an end 130 of outer cutting device 128 and thereby engages sewer lateral cap 116 prior to outer cutting device 128. In the illustrated embodiment, both central cutting device 126 and outer cutting device 128 are cylindrical members centered on the rotating axis of drill engagement portion 120. As drill tool 102 is advanced relative to sewer lateral cap 116 in direction 146 (see FIG. 4), central cutting device 126 encounters and removes material from sewer lateral cap 116 first followed by outer cutting device 128.

A cutout portion 117 of sewer lateral cap 116 (shown in phantom in FIG. 4) is received in cavity 132 between central cutting device 126 and outer cutting device 128. Small chips and other portions of sewer lateral cap 116 removed during the drilling process may be expelled from cavity 132 through openings 134 in sidewall 136. Openings 134 may also be used to insert a tool to retain cutout portion 117 in cavity 132. Drill tool 102 further includes a stop member 140 having a stop surface 142. Stop surface 142 abuts against outer surface 144 of sewer lateral cap 116 to prevent the further advancement of drill tool 102 in direction 146. Stop member 140 is illustrated as a continuous ring. Other exemplary stop members include tabs, bumps, and any other suitable members to prevent the further advancement of drill tool 102 in direction 146.

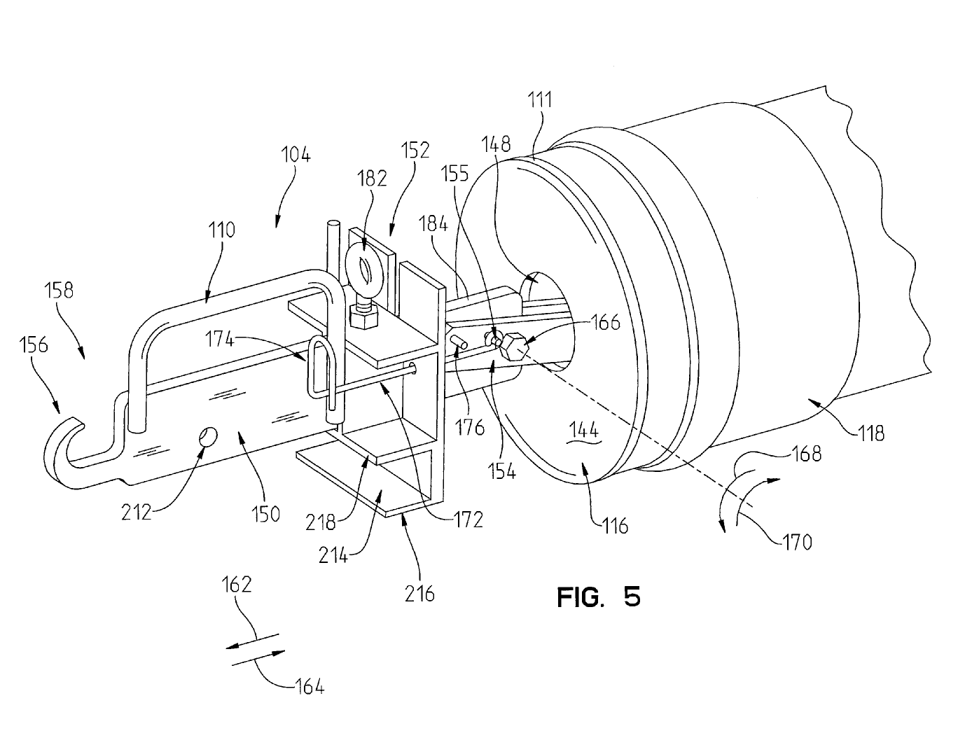

Referring to FIG. 5, an opening 148 is provided in sewer lateral cap 116 once cutout portion 117 is removed. Opening 148 is generally cylindrical like cutting tool 128 and is spaced apart from an edge 111 of sewer lateral cap 116. Although opening 148 is shown being cylindrical, it may be any shape including oblong, square, polygonal, or any suitable shape which permits engagement tool 104 to engage inside portion 105 of sewer lateral cap 116. In one embodiment, engagement tool 104 to engages surface 180 of inside portion 105. In one embodiment, opening 148 is 2⅛ inches in diameter.

Engagement tool 104 is then coupled to sewer lateral cap 116. Engagement tool 104 includes a main body portion 150, a first engagement member 152 and a second engagement member 154. A transport handle 110 is also coupled to main body portion 150. Main body portion 150 further includes a coupler 156 at a first end 158. A chain 160 of handle 106 may be coupled to coupler 156. Coupler 156, in one embodiment, includes a spring loaded clasp to prevent the unintentional decoupling of chain 160 of handle 106. Of course, chain 160 and thus handle 106 may be detached from engagement tool 104.

In the illustrated embodiment, first engagement member 152 is slidably coupled to main body portion 150 and is moveable in direction 162 and direction 164. In one embodiment, first engagement member 152 is moveably coupled to main body portion 150 in a different manner such as rotatably coupled to main body portion 150 through mating threads. In the illustrated embodiment, second engagement member 154 is rotatable coupled to main body portion 150 through a coupler 166 and is rotatable in direction 168 and direction 170. In one embodiment, second engagement member 154 is moveable coupled to main body portion 150 in a different manner.

The rotation of second engagement member 154 in either direction 168 or direction 170 is caused by the movement of an actuator 172. Actuator 172 is rotatably coupled to second engagement member 154 and includes a handle portion 174. Actuator 172 is coupled to second engagement member 154 at a location 155 spaced apart from the axis of rotation of second engagement member 154. A stop 176 is provided to limit the rotation of second engagement member 154 in direction 168. In the illustrated embodiment, stop 176 is a pin and prevents the inversion of second engagement member 154 relative to main body portion 150. In one embodiment, second engagement member 154 is spring biased to rotate in one of direction 168 and direction 170.

In operation, once opening 148 is provided in sewer lateral cap 116 engagement tool 104 is coupled to sewer lateral cap 116. First engagement member 152 is moved in direction 162 away from second engagement member 154. An operator while gripping handle portion 174 moves actuator 172 in direction 162. This movement causes second engagement member 154 to rotate in direction 168 and places second engagement member 154 in a first configuration. As shown in FIG. 5, in the first configuration second engagement member 154 and main body portion 150 may be passed through opening 148 in sewer lateral cap 116.

Referring to FIG. 6, once second engagement member 154 is past inner surface 180 of sewer lateral cap 116 second engagement member 154 is rotated back in direction 170 to a second configuration. In the second configuration, second engagement member 154 has a larger lateral profile than the first configuration. Engagement tool 104 is then moved in direction 162 till second engagement member 154 is in contact with inner surface 180 of sewer lateral cap 116. Next, first engagement member 152 is moved in direction 164 till first engagement member 152 is in contact with outer surface 144 of sewer lateral cap 116. At this point, coupler 182 is tightened to secure first engagement member 152 relative to main body portion 150. In the illustrated embodiment, coupler 182 is an eye bolt which tightens against surface 184 of main body portion 150.

Handle 106 is then coupled to engagement tool 104. Handle 106 includes a bar 190 including a first region 192 for gripping by an operator's left hand and a second region 194 for gripping by an operator's right hand. Handle 106 further includes a mounting base 196 for holding drill tool 102 as discussed herein and weights 198. Chain 160 is coupled to mounting base 196.

Weights 198 aid the operator in providing the momentum in direction 162 to remove sewer lateral cap 116. In one embodiment, the overall weight of handle 106 is about 3 pounds to about 8 pounds. In one embodiment, the overall weight of handle 106 is at least 6 pounds. In one embodiment, the overall weight of handle 106 is about 6 pounds.

In operation, once engagement tool 104 is coupled to sewer lateral cap 116 chain 160 is coupled to coupler 156. Although a chain is illustrated any connecting member including rope, wire, and other suitable connecting members may be used. Handle 106 is then pulled in direction 162 by an operator gripping first region 192 and second region 194 of bar 190. This movement in turn causes engagement tool 104 and sewer lateral cap 116 to move in direction 162. In one embodiment, any device for pulling on engagement tool 104 may be coupled to coupler 156. In one example, a vehicle is coupled to coupler 156 through a suitable connecting member.

By placing first engagement member 152 of engagement tool 104 in contact with outer surface 144 of sewer lateral cap 116 first engagement member 152 prevents the flexure of sewer lateral cap 116 as engagement tool 104 is pulled in direction 162. This assists in preventing second engagement member 154 of engagement tool 104 from breaking through sewer lateral cap 116 while removing sewer lateral cap 116 from sewer lateral pipe 118.

Sewer lateral cap puller tool 100 may be placed in a storage configuration (shown in FIGS. 2 and 3) for ease of transport and storage. Referring to FIG. 1, mounting base 196 includes a bracket 200 having a first upstanding member 202 and a second, spaced apart upstanding member 204. Each of first upstanding member 202 and second upstanding member 204 includes an opening (opening 206 shown for first upstanding member 202) which is sized to receive a first portion 210 of coupler 108. Similarly, main body portion 150 includes an opening 212 which is sized to receive first portion 210 of coupler 108.

Sewer lateral cap puller tool 100 may be placed in a storage configuration for easy transport and storage. To couple handle 106 to engagement tool 104 for storage, second region 194 of handle 106 is received in a holder 214 of engagement tool 104 as shown in FIG. 2. Holder 214 includes a lower member 216 and a spaced apart upper member 218 between which an end of second region 194 is received. Holder 214 is provided on first engagement member 152. First engagement member 152 is moved in direction 164 till it abuts second engagement member 154.

Then, main body portion 150 is placed between first upstanding member 202 and second upstanding member 204 and opening 206 and opening 212 are aligned. First portion 210 of coupler 108 is passed through opening 206 and opening 212. A second portion 220 of coupler 108 is generally upright (extending towards transport handle 110) as first portion 210 is passed through opening 206 and opening 212. Once first portion 210 is passed through opening 206 and opening 212, second portion 220 is rotated such that it is received in a holder 222. Holder 222 includes a first upstanding member 202 and a second spaced apart member 224. With second portion 220 in holder 222, the movement of first portion 210 back out of opening 206 and opening 212 is limited. In one embodiment, coupler 108 is retained relative to opening 206 and opening 212 in a different manner, such as with a detent or a fastener. Chain 160 is then coupled to coupler 156. Drill tool 102 may be stored in a holder 230 provided in mounting base 196 of handle 106.

Once assembled an operator may transport sewer lateral cap puller tool 100 by gripping transport handle 110 and carrying sewer lateral cap puller tool 100 to the intended destination.

Although the invention has been described in detail with reference to certain preferred embodiments, variations and modifications exist within the spirit and scope of the invention as described and defined in the following claims.

1. A method of removing from a sewer lateral pipe a sewer lateral cap having a first side exposed to the fluid carrying portion of the sewer lateral pipe, the method including the steps of:
engaging a portion of the first side of the sewer lateral cap which is exposed to the fluid carrying portion of the sewer lateral pipe with a tool, the portion being spaced apart from an edge of the sewer lateral cap; and
removing the sewer lateral cap with the tool.

2. The method of claim 1, wherein the step of removing the sewer lateral cap with the tool includes the step of translating the tool in a first direction, the first direction being generally aligned with a longitudinal axis of the sewer lateral pipe.

3. The method of claim 1, further including the steps of:
creating an opening in the sewer lateral cap spaced apart from an edge of the sewer lateral cap; and
passing a first engagement member of the tool through the opening, the first engagement member being used to engage the portion of the first side of the sewer lateral cap.

4. The method of claim 3, wherein the opening is created by drilling a hole in the sewer lateral cap.

5. The method of claim 3, wherein the first engagement member of the tool is passed through the opening in a first configuration and engages the portion of the first side in a second configuration, the second configuration having a larger lateral profile than the first configuration.

6. The method of claim 3, further including the step of abutting an outside portion of the sewer lateral cap with a second engagement member of the tool, the second engagement member limiting a flexure of the sewer lateral cap by the first engagement member.

7. The method of claim 6, wherein the second engagement member is translatable relative to a main body portion of the tool and the first engagement member is rotatable relative to the main body portion of the tool.

8. The method of claim 6, further including the step of
coupling a detachable handle to the tool; and
pulling on the handle to remove the sewer lateral cap.

9. A cap puller for removing a cap having an opening created therein which is spaced apart from an edge of the cap, including:
an engagement tool including a main body portion, a first engagement member supported by the main body portion, and a second engagement member supported by the main body portion, the first engagement member having a first configuration and a second configuration which has a larger lateral profile than the first configuration, wherein the first engagement member passes through the opening in the cap in the first configuration and engages an inside portion of the cap proximate the opening in the second configuration and the second engagement member engages an outside portion of the cap proximate the opening; and
an actuator coupled to the first engagement member, the actuator positions the first engagement member in at least one of the first configuration and the second configuration.

10. The cap puller of claim 9, wherein the first engagement member is rotatable relative to the main body portion, the actuator being translatable to cause a rotation of the first engagement member.

11. The cap puller of claim 9, wherein the second engagement member is translatable relative to the main body portion to move the second engagement member from a first position spaced apart from the outside portion of the cap to abutting the outside portion of the cap.

12. The cap puller of claim 9, wherein the first engagement member is positionable independent of the second engagement member.

13. The cap puller of claim 9, further including
a drill tool including a drill engagement portion and a cutting portion, the cutting portion being used to create the opening in the cap; and
a detachable handle which may be coupled to a coupler of the engagement tool.

14. The cap puller of claim 13, wherein the actuator is supported by the engagement tool and the cap puller has a storage configuration wherein the drill tool is supported by the handle, the handle is supported by the engagement tool, and all three are moveable with a transport handle.

15. A cap puller for removing a cap having an opening created therein spaced apart from an edge of the cap, including:
a main body portion;
means for engaging an inside surface of the cap proximate the opening; and
means for engaging an outside surface of the cap proximate the opening.

16. The cap puller of claim 15, further including an actuator to position the means for engaging the inside surface of the cap proximate the opening.

17. The cap puller of claim 15, further including a detachable handle which is coupled to the main body portion and includes a bar for gripping by an operator.

18. A cap puller for removing a cap having an opening created therein spaced apart from an edge of the cap, including
a main body portion;
a transport handle coupled to the main body portion;
a first engagement member coupled to the main body portion and moveable relative to the main body portion;
a holder supported by the main body portion;
a detachable handle being received by the holder when in a storage position of the detachable handle and being coupled to a coupler of the main body portion when in a use position of the detachable handle; and
a drill tool supported by the handle when in a storage position of the drill device.

19. The cap puller of claim 18, wherein in the storage position of the handle, the handle is coupled to the main body portion with a coupler.

20. The cap puller of claim 18, further including a second engagement member, wherein the second engagement member supports the holder and wherein the first engagement member engages an inside portion of the cap proximate the opening in the cap when in use and the second engagement member engages an outside portion of the cap proximate the opening when in use.
